(19) United States
(12) Patent Application Publication
(10) Pub. No.: US 2008/0194236 A1
(43) Pub. Date: Aug. 14, 2008

(54) System and Method for Mass Notification

(76) Inventor: Joseph Frank Johns, New Lenox, IL (US)

Correspondence Address: IPADVISORS, 2038 N. CLARK STREET, STE. 105, CHICAGO, IL, 60614, US

(21) Appl. No.: 12/032,480

(22) Filed: Feb. 15, 2008

Related U.S. Application Data
(63) Continuation-in-part of application No. 11/673,985, filed on Feb. 12, 2007.

(51) Int. Cl. H04M 3/42

(52) U.S. Cl. 455/412.2

(57) ABSTRACT

A system in which users can access a website to sign up and select from a variety of alert options, targeted messages can then be sent to them from our software via text messages on their cellular phone. The user's information is input into a database that is used by our software to direct the text messages. Our software groups users based on the options they select to ensure they get only messages they opt to get. The software then sends out text messages to the users in a group's cellular phone when there is pertinent information for those individuals.

### RELATED APPLICATION

The present application is a continuation-in-part of U.S. patent application Ser. No. 11/673,985, filed 12 Feb. 2007, the complete disclosure of which is hereby expressly incorporated by reference.

### BACKGROUND AND SUMMARY OF THE INVENTION

An electronic messaging system and method is disclosed. The message system and method may be used, for example, in emergency situations or situations where mass noticing of individuals is desired. In such a system and method, a message may be sent to a list of recipients using means such as text messaging, electronic mail, pre-recorded voice messages, or other electronic means.

### BRIEF DESCRIPTION OF THE DRAWINGS

The detailed description particularly refers to the accompanying figures in which:

FIG. 1 is a flow chart showing one embodiment of the present invention; and

FIG. 2 is a schematic of one embodiment of the present invention.

### DETAILED DESCRIPTION OF THE DRAWINGS

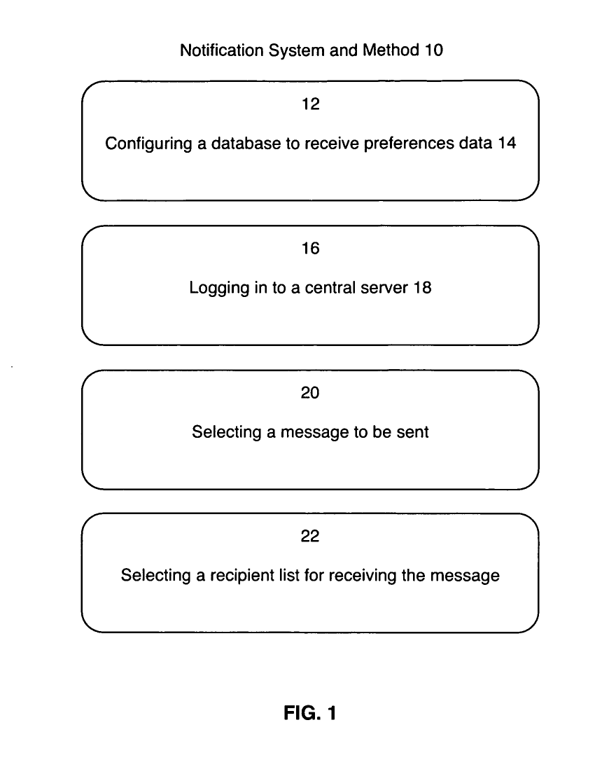

In the embodiment shown in FIG. 1, a system and method for delivering mass notifications is shown. The system and method may be designed to have a pre-programmed database of contact information, or the system may allow for instantaneous configuration of the database.

The system and method illustratively provide for ease of delivery of cellular text messages, electronic messages, and the like to multiple recipients. Such a scenario may be desirable, for example, when a business, municipality, safety organization, police department, or similar entity wishes to notify a number of people as to a particular event or emergency.

It is contemplated that contacts can be entered into a database and delineated by groups, sectors, regions, and/or other categories. In the example of a school system that may need to be notified about school closures, the contacts can be organized by school, grade, school district, or any other type of grouping desirable.

Furthermore, delivery can be based on specific requests of the end user or cellular subscriber. For example, an end user (someone who wishes to be notified as to the event, emergency, status, etc.) can provide preferred contact methods (i.e. phone call, text message, electronic mail, or other means) and may even provide hours that are permitted for contact and prohibited hours where no contact is permitted. Multiple notification methods may also be used, and can be configured by the end user. An end-user login system is contemplated for providing end users the options set forth; however, other systems can be utilized. For example, data can be requested via an e-mail to the end user, or via a paper form that is filled out by the end user. A paper form can thereafter be scanned in to facilitate data entry. The e-mail may prompt the user to go to a website to enter information, or may simply request a response to the e-mail.

A method and system for modifying and updating such data is also contemplated. In one embodiment, this method and system is web-based, and allows users to log in at their convenience to modify any of the data. In another embodiment, a corporation, school, or other entity may have certain time periods during the year in which an invitation to modify the data is provided to the end users.

Such a system contemplates that residents, businesses, customers, and the like interact through an opt-in/opt-out environment helping to insure that the end user only receives messages that he or she wants. This may also be supplemented by a process of determining the need to notify an end user of a particular event. For example, while certain notifications may be sent to an entire group of end users, other messages may be filtered based on criteria previously established—i.e. if an eighth grade class is already on a trip, it may not be necessary to contact the eighth grade parents of a school closure due to weather. Another example may be where a governmental EMA (emergency management agency) needs to send out an emergency message to a specific zip code, thereby targeting recipients where the emergency notification is most appropriate.

In yet another example, an end user may sign up to receive neighborhood watch alerts for the area in which he/she lives, yet the user does not want to receive just any message. In such a scenario, the user may select issue-related messages, or even geographically relevant messages.

It is further contemplated that multiple communication means may be used in certain situations. For example, if it is known that cellular service has been interrupted by a storm or other cause, messages may be routed through landline phones, electronic mail, or other means. Likewise, if Internet service is down, any of the other options may be used.

The system and method may be configured based on the needs of the corporate, governmental, or other entity delivering the messages. The system and method may be further configured based on the number of users and maximum messaging parameters.

The system and method can also allow end users to test their configurations at the point of setup and to pick the messages they wish to receive. As noted above, the preferences may be edited at later times should the end user wish to change his or her preferences or contact information.

As can be seen in FIG. 1, a notification system and method 10 can be configured as follows. A database 12 is configured to receive data 14 relating to the preferences that an end user or a corporate, governmental, or other entity may have set up. Such data can include contact information for the end user, and may be modified by the entity and/or the end user. When it is desired that a mass notification (i.e. a message) be sent, an entity logs in 16 to a central server 18 and selects 20 the message to be sent. The message may be selected from a variety of template messages previously stored on the central server, or may be drafted in part or in whole. The recipient list may also be selected 22 at this time. In selecting the recipient list, groups of categorized recipients are selected in conformance with the needs or intent of the message.

Once the message is selected 20 and the recipient list is selected 22, the system determines how and when to deliver the message based on both the end user settings and the settings of the entity sending the message. For example, the entity could override the end user settings of not wishing to be notified of certain events if the entity determines it is necessary to send the message anyway. However, in most situations, the settings of the end user determine how and when the message is to be sent.

The system contemplates that a website or computer program can be designed to allow for registration of user's information so that governmental operators and/or other entities sending the messages are not required to manually enter contact information for each end user.

In the event an end user wishes to receive a text message as the means of messaging, the central server may be preconfigured to deliver the text message through electronic means that could include a cellular-to-cellular message, or a computer-to-cellular message. In the latter scenario, the central server would be configured to notify the end user based on the settings of the carrier of the cellular service. In such an embodiment, the messages are routed to a provider through an SMTP gateway. The proper delivery address for each end user is chosen from a previously created database based on the cellular provider the end user has chosen. When the end user registers his/her phone, a test message is sent to the end-user's phone to test the connectivity. The registration page also gives an end-user the option to select “not sure” which will send a message to numerous or all providers and will ultimately notify the end user what his/her provider is after receiving responses from the various carriers.

In the event an electronic message is desired by the end user, an e-mail may be sent to the address specified by the end user. Such an e-mail may be marked or flagged as determined by the sending entity.

A pre-recorded voice message may also be sent to the end user, if such is preferred by the end user. The voice message may be a message that was recorded by the entity sending the notification, or the voice message may prompt the end user to call a certain number to receive the message.

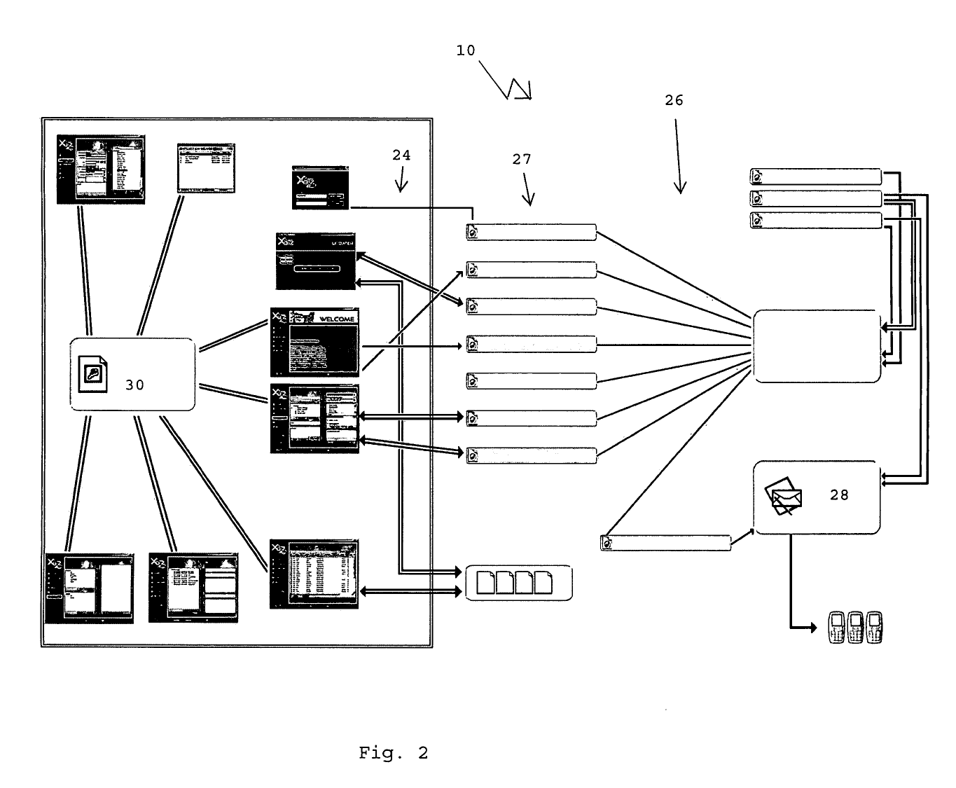

FIG. 2 illustrates how the system 10 allows information to be locally stored, passed through web scripting, stored remotely and passed to external SMTP (Email) networks. The server and client communication 24 is made possible through the use of web posting and XML variant. Microsoft access is used for local data storage and MySql (part of central server 26) for server data storage.

In this embodiment, information such as end recipients' contact information, created groups, created regions, provider routing information and message history is stored with the client software locally in a Microsoft Access database 30. In the alternative, this data could be stored on the central server 26 side. During Login and Message sending, a connection is made to the central server 26 through web scripts 27 passing information enclosed in custom XML tags. In one embodiment, during the login process, user name and password information is encrypted then passed to the server through the regserver.php script and looked up in the server's MySql database to ensure user has been granted access. Information is then passed back to the client notifying the software if it has proper privileges.

During Message sending, a connection is made to the central server 26 through the SendMail.php server script 27 passing the recipients, message body and subject. Based on email and provider information passed to the server, messages are then created and sent to the appropriate outgoing SMTP server 28 using the central server's email software.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the spirit and scope of the disclosure as defined by the appended claims.

What is claimed is:

1. A method for sending multiple electronic notification messages, the method comprising the steps of:
receiving contact data relating to contact information and notification preferences of an end user,
storing the contact data on a database,
providing a log-in to a central server, the central server being connected to the database,
providing a template for a message sender to use when constructing an electronic message,
determining the time at which the message would be sent,
providing a subset of end users that may be selected, and
sending the message to a plurality of end users in the preferred notification manner of each of the end users.

2. The method of claim 1, wherein the receiving data step comprises receiving a paper form having an end user's data thereon.

3. The method of claim 1, wherein the receiving data step comprises an end user entering data on a website.

4. The method of claim 1, wherein the receiving data step comprises an end user responding to an e-mail message with end user data.

5. The method of claim 1, wherein the message sent to the end user is at least one selected from the group comprising a pre-recorded voice message, an e-mail message, and a text message.

6. The method of claim 1, wherein the determining step considers both the data provided by the end user and the preferences provided by the message sender.

7. The method of claim 1, wherein the selected subset of end users may be determined by a software program.

8. The method of claim 1, wherein the selected subset of end users may be determined by the message sender.

9. The method of claim 1, wherein the message is sent via at least one provider's gateway that is predetermined and stored in the database.

10. The method of claim 9, wherein the provider gateway is one of a cellular network and an SMTP network.

11. The method of claim 1, further comprising the step of flagging the message.

12. A method for sending multiple electronic notification messages, the method comprising the steps of:
receiving contact data relating to contact information and notification preferences of an end user,
storing the contact data on a database,
creating subsets of end users on the database,
providing a log-in to a central server, the central server being connected to the database,
addressing an electronic message to a subset of end users selected by a message sender, and
sending the message to the selected subset of end users in the preferred notification manner of each of the end users.

13. The method of claim 12, wherein the receiving data step comprises receiving a paper form having an end user's data thereon.

14. The method of claim 12, wherein the receiving data step comprises an end user entering data on a website.

15. The method of claim 12, wherein the receiving data step comprises an end user responding to an e-mail message with end user data.

16. The method of claim 12, wherein the message sent to the end user is at least one selected from the group comprising a voice message, a text message, and an e-mail message.

17. The method of claim 12, wherein the selected subset of end users may be further modified by software using data stored in the database.

18. The method of claim 12, further comprising the step of flagging the message being sent to the end users.
